(19) United States
(12) Patent Application Publication
(10) Pub. No.: US 2026/0155137 A1
(43) Pub. Date: Jun. 4, 2026

(54) Handling ASR Speech Loss using LLM Prompting

(71) Applicant: Google LLC, Mountain View, CA (US)

(72) Inventors: Khalid Salama, Zurich (CH); Antonious Mamdouh Girgis Bebawy, San Jose, CA (US)

(73) Assignee: Google LLC, Mountain View, CA (US)

(21) Appl. No.: 18/969,241

(22) Filed: Dec. 4, 2024

(51) Int. Cl. G10L 15/01; G10L 15/18; G10L 15/22

(52) U.S. Cl. CPC G10L 15/01; G10L 15/18; G10L 15/22

(57) ABSTRACT

A method includes receiving a textual prompt directed toward a large language model (LLM)-powered assistant. The method also includes determining the textual prompt was generated by an automatic recognition system (ASR) system and, based on determining the textual prompt was generated by the ASR system, structuring a speech misrecognition awareness prompt. Here, the speech misrecognition awareness prompt includes: an awareness message that informs the LLM-powered assistant that the text prompt was generated by the ASR system and may be prone to speech recognition errors; and one or more error-correction pairs where each error-correction pair includes a corresponding misrecognized phrase and a corresponding correction phrase that corrects the corresponding misrecognized phrase. The method also includes processing, using the LLM-powered assistant, the textual prompt conditioned on the speech misrecognition awareness prompt to fulfill performance of the task specified by the natural language query.

### TECHNICAL FIELD

This disclosure relates to handling automated speech recognition (ASR) speech loss using large language model (LLM) prompting.

### BACKGROUND

Large language models (LLMs) are increasingly used to provide conversational experiences between users and digital assistant interfaces executing on user devices. The input to LLMs can be the output of an automated speech recognition (ASR) system. ASR systems are not perfect and have been known to demonstrate speech losses as a result of misrecognizing words.

### SUMMARY

One aspect of the disclosure provides a computer-implemented method for correcting large language model (LLM) prompts generated from automated speech recognition (ASR) systems. The computer-implemented method executes on data processing hardware that causes the data processing hardware to perform operations that include receiving, as output from an ASR system, a textual prompt directed toward a LLM-powered assistant. Here, the ASR system is configured to generate the textual prompt from input audio data characterizing an utterance of a natural language query that specifies a task for the LLM-powered assistant to perform. The operations also include determining the textual prompt was generated by the ASR system and, based on determining the textual prompt was generated by the ASR system, structuring a speech misrecognition awareness prompt. Here, the speech misrecognition awareness prompt includes: an awareness message that informs the LLM-powered assistant that the text prompt was generated by the ASR system and may be prone to speech recognition errors; and one or more error-correction pairs where each error-correction pair includes a corresponding misrecognized phrase and a corresponding correction phrase that corrects the corresponding misrecognized phrase. The operations also include processing, using the LLM-powered assistant, the textual prompt conditioned on the speech misrecognition awareness prompt to fulfill performance of the task specified by the natural language query.

This aspect may include one or more of the following optional features. In some implementations, the operations further include generating, as output from the LLM-powered assistant, a response indicating performance of the task specified by the natural language query and providing, for output from a user device, the response generated as output from the LLM-powered assistant. In some examples, the one or more error-correction pairs are fixed.

In some implementations, the operations further include, based on determining the textual prompt was generated by the ASR system, processing the textual prompt to generate a corresponding phoneme representation of the textual prompt and querying, using the corresponding phoneme representation of the textual prompt, a corrections datastore to retrieve any candidate error-correction pairs stored in the corrections datastore that are phonetically similar to the textual prompt. Here, the one or more error-correction pairs of the speech misrecognition awareness prompt include each candidate error-correction pair retrieved from the correction datastore that is phonetically similar to the textual prompt. In these implementations, each candidate error-correction pair stored in the correction data store may include a candidate misrecognized phrase, a corresponding phoneme representation of the candidate misrecognized phrase, a candidate correction phrase that corrects the candidate misrecognized phrase, and a corresponding phoneme representation of the candidate correction phrase. Here, retrieving any candidate error-correction pairs stored in the corrections datastore that are phonetically similar to the textual prompt includes, for each corresponding candidate error-correction pair stored in the correction datastore, determining whether a corresponding similarity metric between the corresponding phoneme representation of the textual prompt and the corresponding phoneme representation of at least one of the candidate misrecognized phrase or the candidate correction phrase satisfies a similarity threshold and when the corresponding similarity metric satisfies the similarity threshold, retrieving the corresponding candidate error-correction pair. The corresponding phoneme representation of each of the textual prompt, the candidate misrecognized phrase, and the candidate correction phrase may include a corresponding phoneme sequence and the corresponding similarity metric may include an edit distance.

The one or more error-correction pairs of the awareness prompt may be stored in a correction datastore that stores candidate error-correction pairs. These implementations may further include a selection process that selects each corresponding candidate error-correction pair stored in the correction datastore by accessing a speech query log including a corpus of transcribed speech queries and identifying consecutive transcribed speech query pairs in the corpus of transcribed speech queries. Here, each corresponding transcribed speech query in the corpus of transcribed speech queries includes corresponding metadata that indicates a corresponding timestamp of the corresponding transcribed speech query and each consecutive transcribed speech query pair includes a respective pair of transcribed speech queries having corresponding timestamps that occur within a threshold time. For each consecutive transcribed speech query pair identified in the corpus of transcribed speech queries, the selection process includes obtaining a corresponding phoneme representation for each transcribed speech query in the respective pair of transcribed speech queries, determining whether the respective pair of transcribed speech queries are phonetically similar to one another based on the corresponding phoneme representations of the respective pair of transcribed speech queries, and based on when the respective pair of transcribed speech queries are phonetically similar, storing the respective pair of transcribed speech queries in the correction datastore as a corresponding one of the candidate error-correction pairs, wherein the one of the transcribed speech queries in the respective pair of transcribed speech queries that has the earlier corresponding timestamp includes the corresponding candidate misrecognized phrase and the other one of the transcribed speech queries in the respective pair of transcribed speech queries that has the later corresponding time stamp includes the corresponding candidate correction phrase.

In these implementations, the corresponding metadata of each corresponding transcribed speech query in the corpus of transcribed speech queries may further indicate a corresponding user satisfaction score associated with the corresponding transcribed speech query and for each consecutive transcribed speech query pair, storing the respective pair of transcribed speech queries in the correction datastore as a corresponding one of the candidate error-correction pairs is further based on when the corresponding user satisfaction score associated with the one of the transcribed speech queries in the respective pair of transcribed speech queries that has the earlier corresponding timestamp satisfies a low satisfaction score threshold and the corresponding user satisfaction score associated with the other of the transcribed speech queries in the respective pair of transcribed speech queries that has the later corresponding timestamp satisfies a high satisfaction score threshold. The correction datastore may include a personal correction datastore associated with a user that issued the natural language query and the corpus of transcribed speech queries in the speech query log accessed by the selection process may all be issued by the same user that issued the natural language query. The correction datastore may include a global correction datastore and the candidate error-correction pairs stored in the global correction datastore are obtained from multiple different users and the corpus of transcribed speech queries in the speech query log accessed by the selection process may be issued by the multiple different users.

Another aspect of the disclosure provides a system that includes data processing hardware and memory hardware in communication with the data processing hardware, the memory hardware storing instructions that when executed on the data processing hardware cause the data processing hardware to perform operations. The operations include receiving, as output from an automated speech recognition (ASR) system, a textual prompt directed toward a large language model (LLM)-powered assistant. Here, the ASR system is configured to generate the textual prompt from input audio data characterizing an utterance of a natural language query that specifies a task for the LLM-powered assistant to perform. The operations also include determining the textual prompt was generated by the ASR system and, based on determining the textual prompt was generated by the ASR system, structuring a speech misrecognition awareness prompt. Here, the speech misrecognition awareness prompt includes: an awareness message that informs the LLM-powered assistant that the text prompt was generated by the ASR system and may be prone to speech recognition errors; and one or more error-correction pairs where each error-correction pair includes a corresponding misrecognized phrase and a corresponding correction phrase that corrects the corresponding misrecognized phrase. The operations also include processing, using the LLM-powered assistant, the textual prompt conditioned on the speech misrecognition awareness prompt to fulfill performance of the task specified by the natural language query.

This aspect may include one or more of the following optional features. In some implementations, the operations further include generating, as output from the LLM-powered assistant, a response indicating performance of the task specified by the natural language query and providing, for output from a user device, the response generated as output from the LLM-powered assistant. In some examples, the one or more error-correction pairs are fixed.

In some implementations, the operations further include, based on determining the textual prompt was generated by the ASR system, processing the textual prompt to generate a corresponding phoneme representation of the textual prompt and querying, using the corresponding phoneme representation of the textual prompt, a corrections datastore to retrieve any candidate error-correction pairs stored in the corrections datastore that are phonetically similar to the textual prompt. Here, the one or more error-correction pairs of the speech misrecognition awareness prompt include each candidate error-correction pair retrieved from the correction datastore that is phonetically similar to the textual prompt. In these implementations, each candidate error-correction pair stored in the correction data store may include a candidate misrecognized phrase, a corresponding phoneme representation of the candidate misrecognized phrase, a candidate correction phrase that corrects the candidate misrecognized phrase, and a corresponding phoneme representation of the candidate correction phrase. Here, retrieving any candidate error-correction pairs stored in the corrections datastore that are phonetically similar to the textual prompt includes, for each corresponding candidate error-correction pair stored in the correction datastore, determining whether a corresponding similarity metric between the corresponding phoneme representation of the textual prompt and the corresponding phoneme representation of at least one of the candidate misrecognized phrase or the candidate correction phrase satisfies a similarity threshold and when the corresponding similarity metric satisfies the similarity threshold, retrieving the corresponding candidate error-correction pair. The corresponding phoneme representation of each of the textual prompt, the candidate misrecognized phrase, and the candidate correction phrase may include a corresponding phoneme sequence and the corresponding similarity metric may include an edit distance.

The one or more error-correction pairs of the awareness prompt may be stored in a correction datastore that stores candidate error-correction pairs. These implementations may further include a selection process that selects each corresponding candidate error-correction pair stored in the correction datastore by accessing a speech query log including a corpus of transcribed speech queries and identifying consecutive transcribed speech query pairs in the corpus of transcribed speech queries. Here, each corresponding transcribed speech query in the corpus of transcribed speech queries includes corresponding metadata that indicates a corresponding timestamp of the corresponding transcribed speech query and each consecutive transcribed speech query pair includes a respective pair of transcribed speech queries having corresponding timestamps that occur within a threshold time. For each consecutive transcribed speech query pair identified in the corpus of transcribed speech queries, the selection process includes obtaining a corresponding phoneme representation for each transcribed speech query in the respective pair of transcribed speech queries, determining whether the respective pair of transcribed speech queries are phonetically similar to one another based on the corresponding phoneme representations of the respective pair of transcribed speech queries, and based on when the respective pair of transcribed speech queries are phonetically similar, storing the respective pair of transcribed speech queries in the correction datastore as a corresponding one of the candidate error-correction pairs, wherein the one of the transcribed speech queries in the respective pair of transcribed speech queries that has the earlier corresponding timestamp includes the corresponding candidate misrecognized phrase and the other one of the transcribed speech queries in the respective pair of transcribed speech queries that has the later corresponding time stamp includes the corresponding candidate correction phrase.

In these implementations, the corresponding metadata of each corresponding transcribed speech query in the corpus of transcribed speech queries may further indicate a corresponding user satisfaction score associated with the corresponding transcribed speech query and for each consecutive transcribed speech query pair, storing the respective pair of transcribed speech queries in the correction datastore as a corresponding one of the candidate error-correction pairs is further based on when the corresponding user satisfaction score associated with the one of the transcribed speech queries in the respective pair of transcribed speech queries that has the earlier corresponding timestamp satisfies a low satisfaction score threshold and the corresponding user satisfaction score associated with the other of the transcribed speech queries in the respective pair of transcribed speech queries that has the later corresponding timestamp satisfies a high satisfaction score threshold. The correction datastore may include a personal correction datastore associated with a user that issued the natural language query and the corpus of transcribed speech queries in the speech query log accessed by the selection process may all be issued by the same user that issued the natural language query. The correction datastore may include a global correction datastore and the candidate error-correction pairs stored in the global correction datastore are obtained from multiple different users and the corpus of transcribed speech queries in the speech query log accessed by the selection process may be issued by the multiple different users.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example system for guiding a large language model (LLM) to generate corrected responses to user queries based on imperfect speech recognition.

FIG. 2 is a schematic view of an example error-correction pair selection process for selecting error-correction pairs stored in a correction data store.

FIGS. 3A-3C are schematic views of a user providing an input indication to correct a misrecognized previous transcription.

FIG. 4 is a flowchart of an example arrangement of operations for a method of generating corrected responses to user queries based on imperfect speech recognition.

FIG. 5 is a schematic view of an example computing device that may be used to implement the systems and methods described herein.

Like reference symbols in the various drawings indicate like elements.

### DETAILED DESCRIPTION

Automatic speech recognition (ASR) systems are becoming increasingly popular in client devices as the ASR systems continue to provide more accurate transcriptions of what users speak. Recently, end-to-end (E2E) ASR models have gained popularity in achieving state-of-the-art performance in accuracy and latency. In contrast to conventional hybrid ASR systems that include separate acoustic, pronunciation, and language models, E2E ASR models apply a sequence-to-sequence approach to jointly learn acoustic and language modeling in a single neural network that is trained end to end from training data, e.g., utterance-transcription pairs. Still, in some instances, ASR models generate inaccurate transcriptions that misrecognize what the user actually spoke. This is often the case when user speaks a unique phrase that is sparse in or non-existent in training data used to train the ASR model.

Large language models (LLMs) are increasingly used to perform complex language-based tasks, such as speech recognition or transcription, text summarization, text-to-text translation, text prediction, natural language understanding, or text generation. Many LLMs are prompted based on transcriptions of audio data generated from ASR systems, the errors that result from inaccurate transcriptions will propagate into the LLM prompt. Since ASR systems generate inaccurate transcriptions, there is a need for prompt structuring that accounts for transcriptions that misrecognize what the user actually spoke. Moreover, a conventional LLM is not able to learn from a user's past interactions with the LLM and, thus, may repeat past mistakes. We can address the error propagation by making the LLM aware of potential misrepresentations of the true prompt. This may also include making the LLM aware of common corrections associated with the misrepresentations and common corrections associated with specific users.

Implementations herein are directed toward correcting textual prompts directed toward a LLM-powered assistant that were generated by an ASR system.

Specifically, implementations are directed toward receiving, as output from an ASR system, a textual prompt directed toward the LLM-powered assistant, and based on determining the textual prompt was generated by the ASR system, a prompt structurer can structure a speech misrecognition awareness prompt that includes an awareness message and one or more error-correction pairs. Here, the awareness message informs the LLM-powered assistant that the text prompt was generated by the ASR system and may be prone to speech recognition errors, while each of the one or more error-correction pairs includes a corresponding misrecognized phrase and a corresponding correction phrase that corrects the corresponding misrecognized phrase. The LLM-powered assistant can then process the textual prompt conditioned on the speech misrecognition awareness prompt to fulfill performance of the task specified by the natural language query

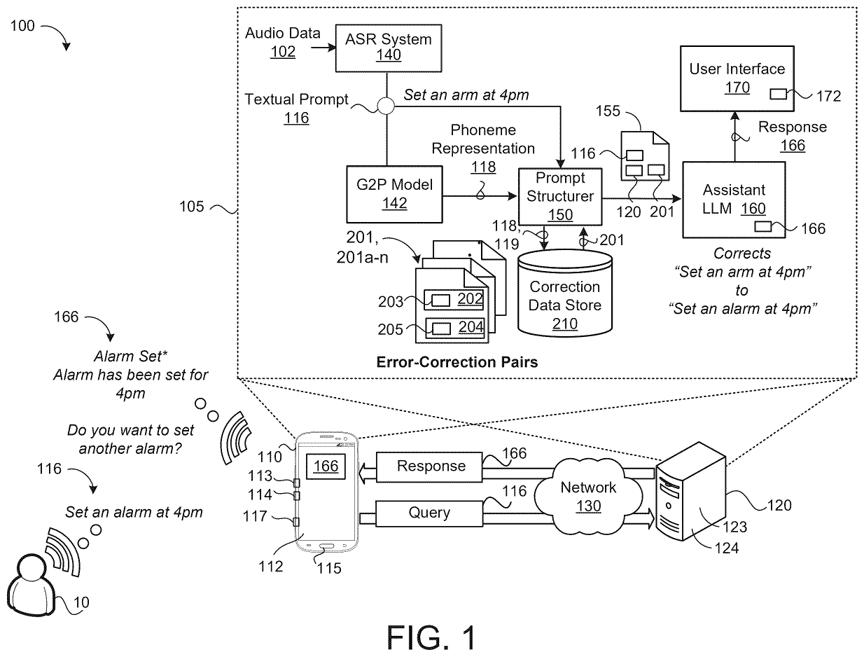

FIG. 1 illustrates an example system 100 for allowing a spoken conversation between a user 10 and an assistant LLM 160. The assistant LLM 160 may be interchangeable referred to as an LLM-powered assistant 160. A conversational assistant application 105 may execute on a user device 110 associated with the user 10 to enable the user 10 and the assistant LLM 160 to interact with one another through spoken conversation. The conversational assistant application 105 may access various components for facilitating the spoken conversation in a natural manner between the user 10 and the assistant LLM 160. For instance, through the use of application programming interfaces (APIs) or other types of plug-ins, the conversation assistant application 105 may access an automated speech recognition (ASR) system 140, a grapheme-to-phoneme (G2P) model 142, a prompt structurer 150, the assistant LLM 160 (e.g., LLM-powered assistant), and a user interface 170.

The system 100 may include the user device 110, a remote computing system 120, and a network 130. The user device 110 may include data processing hardware 113 and memory hardware 114. The user device 110 may include, or be in communication with, an audio capture device 115 (e.g., an array of one or more microphones) for converting utterances of natural language queries 116 spoken by the user 10 into corresponding audio data 102 (e.g., electrical signals or digital data). In lieu of spoken input, the user 10 may input a textual representation of the natural language query 116 via the user interface 170 executing on the user device 110. In scenarios when the user speaks a natural language query 116 captured by the microphone 115 of the user device 110, the ASR system 140 executing on the user device 110 or the remote computing system 120 may process the corresponding audio data 102 to generate a transcription of the query 116. Here, the transcription conveys the textual prompt 116 provided as input to the conversational assistant application 105. The ASR system 140 may implement any number and/or type(s) of past, current, or future speech recognition systems, models and/or methods including, but not limited to, an end-to-end speech recognition model, such as streaming speech recognition models having recurrent neural network-transducer (RNN-T) model architectures, a hidden Markov model, an acoustic model, a pronunciation model, a language model, and/or a naäve Bayes classifier. While the ASR system 140 is shown as a component of the conversation assistant application 105, the ASR system 140 may be a standalone component that transcribes user speech and provides the transcribed user speech as input text to the conversation assistant application 105 (e.g., the transcribed user speech may be provided into a text field for prompting the assistant LLM 160).

The user device 110 may be any computing device capable of communicating with the remote computing system 120 through the network 130. The user device 110 includes, but is not limited to, desktop computing devices and mobile computing devices, such as laptops, tablets, smart phones, smart speakers/displays, digital assistant devices, smart appliances, internet-of-things (IoT) devices, infotainment systems, vehicle infotainment systems, and wearable computing devices (e.g., headsets, smart glasses, and/or watches).

The remote computing system 120 may be a distributed system (e.g., a cloud computing environment) having scalable elastic resources. The resources include computing resources 123 (e.g., data processing hardware) and/or storage resources 124 (e.g., memory hardware). Additionally or alternatively, the remote computing system 120 may be a centralized system. The network 130 may be wired, wireless, or a combination thereof, and may include private networks and/or public networks, such as the Internet.

With continued reference to FIG. 1, the components leveraged by the conversational assistant application 105 may execute on the data processing hardware 113 of the user device 110 or on the data processing hardware 123 of the remote computing system 120. In some implementations, the components leveraged by the conversational assistant application 105 executes on both the data processing hardware 113 of the user device 110 and the data processing hardware 123 of the remote computing system 120. For instance, one or more components of the conversational assistant application 105 may execute on the data processing hardware 113 of the user device 110 while one or more other components of the conversational assistant application 105 may execute on the remote computing system 120.

The assistant LLM 160 may power the conversational assistant application 105 to function as a personal chat bot capable of having dialog conversations with the user 10 in natural language and performing tasks/actions on the user's behalf. In some examples, the assistant LLM 160 includes an instance of Gemini, Bard, LaMDA, BERT, Meena, ChatGPT, or any other previously trained LLM. These previously trained LLMs have been previously trained on enormous amounts of diverse data and are capable of engaging in corresponding conversations with users in a natural and intuitive manner. However, these LLMs have a plurality of machine learning (ML) layers and hundreds of millions to hundreds of billions of ML parameters.

During a user's turn of the spoken conversation between the user 10 and the assistant LLM 160, the user device 110 captures audio data 102 characterizing an utterance of a query 116 spoken by the user 10 and directed toward the assistant LLM 160 to solicit a response from the assistant LLM 160. For instance, the query 116 may specify a particular question that the user 10 would like the assistant LLM 160 to answer and the assistant LLM 160 may generate a response 166 that answers the question. The query 116 may similarly correspond to a request for information and the assistant LLM 160 may generate the response 166 conveying the requested information. For instance, the user 10 may say “What is the weather this afternoon?” corresponding to a request from the user 10 to the user device 110 to retrieve the requested information pertaining to the weather. While the term query 116 is used, the query 116 may correspond to any natural language dialog (e.g., a greeting) directed toward the assistant LLM 160 during the user's turn in the spoken conversation between the user 10 and the assistant LLM 160. The query 116 may also correspond to a request by the user 10 to invoke an action. For instance, the user 10 may say “Set an alarm at 4 pm”, corresponding to a request from the user 10 to the assistant LLM 160 to invoke the action of setting an alarm at the designated time of 4 pm. The user 10 may speak the utterance of the query 116 in natural language and the ASR system 140 may perform speech recognition on the audio data 102 characterizing the utterance of the query 116 to generate a textual representation of the query 116 (e.g., the transcription) spoken by the user 10. The textual representation of the query 116 may be simply referred to as a textual prompt 116. Additionally, the G2P model 142 may process the textual prompt 116 to generate a corresponding phoneme representation 118 of the textual prompt 116.

The prompt structurer 150 may receive the textual prompt 116 and determine whether the textual prompt 116 was generated by the ASR system 140 from corresponding audio data 102 characterizing a spoken utterance compared to a textual prompt that was manually typed/input by the user 10. That is, a textual prompt 116 generated by the ASR system 140 may be prone to speech recognition errors, and thus, may not accurately convey the query/prompt spoken by the user 10. Whereas a textual prompt manually typed/input by the user 10 is assumed to be accurate. This determination may be based on metadata or annotations corresponding to the textual prompt 116. For instance, the textual prompt 116 may include metadata or annotations that indicate that the ASR system 140 generated the textual prompt 116 or otherwise indicate that the textual prompt 116 was derived from the ASR system 140. By the same notion, a textual prompt 116 that was manually typed/input into a text field (not shown) displayed on a screen 112 of the user device 110 by the conversation application 120 may include metadata or annotations that indicate the textual prompt 116 was initially input as text, and thus, not generated by an ASR system 140. Notably, the textual prompt 116 may be processed by the G2P model 142 to generate the corresponding phoneme representation 118 of the textual prompt 116 based on the prompt structurer 150 determining the textual prompt 116 was generated by the ASR system 140.

Thereafter, based on determining the textual prompt 116 was generated by the ASR system 140, the prompt structurer 150 structures a speech misrecognition awareness prompt 155 that includes an awareness message 120 and one or more error-correction pairs 201, 201a-n. Here, the awareness message 120 may inform the assistant LLM 160 that the textual prompt 116 may be prone to speech recognition errors. For instance, the awareness prompt 155 structured by the prompt structurer 150 may concatenate the textual prompt 116 to the awareness message 120 such that the awareness message 120 includes natural language text conveying the message, “The prompt is produced by an imperfect ASR system which may have speech recognition errors.” Additionally, each of the one or more error-correction pairs 201 included in the speech misrecognition awareness prompt 155 include a corresponding misrecognized phrase 202 and a corresponding correction phrase 204 that corrects the corresponding misrecognized phrase 202. As used herein, a misrecognized phrase 202 includes a transcription produced by an ASR system for a speech utterance that includes one or more misrecognized words or terms and a correction phrase 204 that corrects the corresponding misrecognized phrase 202 includes a correction of the one or more terms that were misrecognized by the ASR system in the misrecognized phrase 202. Thereafter, the prompt structurer 150 passes the speech misrecognition awareness prompt 155 and the textual prompt 116 as input to the assistant LLM 160 to enable the assistant LLM 160 to generate a response 166 specified by the user's query 116. Alternatively, in scenarios when the prompt structurer 150 instead determines the textual prompt 116 was not generated by the ASR system 140, the prompt structurer 150 may simply pass the textual prompt 116 for input to the assistant LLM 160 directly and bypass generating the speech misrecognition awareness prompt 155 that includes the awareness message 120 and the one or more error-correction pairs 201.

In the example shown, the original utterance spoken by the user 10 includes the spoken prompt 116 stating “Set an alarm at 4 pm”, however, the resulting textual prompt 116 output by ASR system 140 is misrecognized as “Set an arm at 4 pm”. Consequently, if the misrecognized textual prompt 116 is passed to the assistant LLM 160 without including the speech misrecognition awareness prompt 155, the assistant LLM 160 might either execute a different task than the one requested by the user 10 or reject the textual prompt 116 altogether due to an inability to interpret the task that the user 10 would like the assistant LLM 160 to perform. In both cases, the user experience would be negatively impacted. As will become apparent, the misrecognized textual prompt 116 conditioned on the speech misrecognition awareness prompt 155 guides the assistant LLM 160 to accurately fulfill performance of the task specified by the natural language query spoken by the user 10 despite the textual prompt 116 including one or more terms or phrases that were misrecognized by the ASR system 140 when processing the input audio data 102 characterizing the spoken utterance of the natural language query.

The one or more error-correction pairs 201 included in the speech misrecognition awareness prompt 155 may be retrieved by the prompt structurer 150 from a corrections datastore 210. The correction datastore 210 may reside on the memory hardware 114 of the user device 110 and/or the memory hardware 124 of the remote system 120. The corrections datastore 210 may store the plurality of candidate error-correction pairs 201. The candidate error-correction pairs 201 may generally be in the form of short phrases, for instance, in the form of phrases of two or more words, rather than complete sentences. Continuing with the example shown, one of the candidate error-correction pairs 201 retrieved from the correction datastore 210 for inclusion in the awareness prompt 155 may include the candidate misrecognized phrase 202 of “Set an arm” and the corresponding candidate correction phrase 204 of “Set an alarm”.

The candidate error-correction pairs 201 stored in the correction datastore 210 may be specific to the user 10 or be associated with a group of individuals from a user population. The prompt structurer 150 may provide a query 119 to the correction data store 210 to retrieve the one or more error-correction pairs 201 for inclusion in the speech misrecognition awareness prompt 155 in response to determining that the textual prompt 116 was generated by the ASR system 140. The query 119 may optionally include a user identifier so that only candidate error-correction pairs 201 specific to the particular user 10 are retrieved for inclusion in the awareness prompt 155.

In some implementations, the one or more error-correction pairs 201 included in the awareness prompt 155 are fixed. That is, all awareness prompts 155 structured by the prompt structurer 150 include the same one or more error-correction pairs 201 independent of the underlying textual prompts 116 output by the ASR system 140. Accordingly, the fixed one or more error-correction pairs 201 included in the awareness prompt 155 may include all of the candidate error-correction pairs 201 stored in the correction data store 210 or only those candidate error-correction pairs 201 specific to the particular user 10. Notably, the number of fixed error-correction pairs 201 included in the awareness prompt 155, and therefore processed by the assistant LLM 160, can become large when the correction data store 210 stores a large volume of candidate error-correction pairs 201. Generally, processing costs and latency of the assistant LLM 160 may be impacted as the number of tokens representing the fixed error-correction pairs 201 increases.

In other implementations, the prompt structurer 150 retrieves only those candidate error-correction pairs 201 from the correction data store 210 that are phonetically similar to the textual prompt 116 for inclusion in the speech misrecognition awareness prompt 155. In these cases, the prompt structurer 150 dynamically selects the candidate error-correction pairs 201 for the awareness prompt 155 in real-time. This approach optimizes the assistant LLM 160 for processing of the textual prompt 116 conditioned on the awareness prompt 155 to ensure that the assistant LLM 160 considers only the error-correction pairs 201 that are most likely to be relevant to the underlying textual prompt 116. In these implementations, upon determining the textual prompt 116 was generated by the ASR system 140, the G2P model 142 initially processes the textual prompt 116 to generate a corresponding phoneme representation 118 of the textual prompt 116 and the prompt structurer 150 uses the corresponding phoneme representation 118 to query the correction datastore 210 to retrieve any candidate error-correction pairs 201 that are phonetically similar to the textual prompt 116. As result, the one or more error-correction pairs 201 included in the awareness prompt 155 include each candidate error-correction pair 201 retrieved from the correction datastore 210 that is phonetically similar to the textual prompt 116.

Each candidate error-correction pair 201 stored in the correction datastore 210 may include a candidate misrecognized phrase 202, a corresponding phoneme representation 203 of the candidate misrecognized phrase 202, a candidate correction phrase 204 that corrects the candidate misrecognized phrase 202, and a corresponding phoneme representation 205 of the candidate correction phrase 204. In some examples, the prompt structurer 150 retrieves candidate error-correction pairs 201 phonetically similar to the textual prompt 116 by, for each corresponding candidate error-correction pair 201 stored in the correction datastore: determining whether a similarity metric between the corresponding phoneme representation 118 of the textual prompt 116 and the corresponding phoneme representation 203, 205 of at least one of the candidate misrecognized phrase 202 or the candidate correction phrase 204 satisfies a similarly threshold; and retrieving the corresponding candidate error-correction pair when the corresponding similarity metric satisfies the similarity threshold. In these examples, the corresponding phoneme representation 118, 203, 205 of each of the textual prompt 116, the candidate misrecognized phrase 202, and the candidate correction phrase 204 includes a corresponding phoneme sequence and the corresponding similarity metric includes an edit distance. In addition to or in lieu of using the phoneme representation 118, the prompt structurer may simply determine a similarity metric between the grapheme representations of the textual prompt 116 and at least one of the candidate misrecognized phrases 202 or the correction phrases 204 stored in the correction data store. The similarity metric may be an edit distance such as a Levenshtein distance.

After the prompt structurer 150 passes the speech misrecognition awareness prompt 155 and the textual prompt 116 to the assistant LLM 160, the assistant LLM 160 may process the textual prompt 116 conditioned on the awareness prompt 155 to fulfill performance of the task specified by the natural language query spoken by the user 10 despite the textual prompt 116 including a misrecognized word, e.g., the ASR system 150 misrecognized the term “arm” instead of “alarm”. The speech misrecognition awareness prompt 155 provides the assistant LLM 160 with context to guide the assistant LLM 160 to accurately identify and fulfill the task that the user 10 wants to be performed even though identification of the task cannot be ascertained from the textual prompt 116 in the presence of the misrecognized word. For instance, and continuing with the example, the assistant LLM 160 may determine that an error is present in the example textual prompt 116 “Set an arm at 4 pm” based on the speech misrecognition awareness prompt 155 and generate a corrected textual prompt based on the error-correction pairs 201 includes in the speech misrecognition awareness prompt 155. Here, the assistant LLM 160 may correct the example textual prompt 116 “Set an arm at 4 pm” to “Set an alarm at 4 pm” based on the speech misrecognition awareness prompt 155 including an example error-correction pair 201 that includes an example candidate correction phrase 204 “Set an alarm” that corrects the example candidate misrecognized phrase 202 “Set an arm”.

The textual prompt 116 conditioned on the speech misrecognition awareness prompt 155 may guide the assistant LLM 160 to generate the response 166 to the query 116 as output from the assistant LLM 160 even though the textual prompt 116 output by the ASR system 140 includes one or more misrecognized terms. The response 166 may correspond to a receipt or acknowledgement from the assistant LLM 160 that the task conveyed by the user in the spoken prompt has been fulfilled by the assistant LLM 160. Additionally, the response 166 may include results or an answer to a query specified by the spoken prompt.

The conversational assistant application 105 is configured to provide, for output from the user device 110, the response 166 generated by the assistant LLM 160. Here, the user interface 170 may audibly output, from an audio output device (e.g., acoustic speaker) 117, the response 166 as synthesized speech. For instance, the user interface 170 may include a text-to-speech (TTS) system 172 that converts a textual representation of the response 166 into synthesized speech conveying the response 166. Additionally, or alternatively, the conversational assistant application 105 may instruct the user interface 170 to display, on a screen 112 in communication with the user device 110, text representing the response 166. In the example shown, the user speaks the natural query 116 of “Set an alarm at 4 pm” and the assistant LLM 160 generates the response 166 that instructs the user device 110 to set at alarm. This response may include a textual response “Alarm has been set for 4 pm”, which may be audibly output as synthesized speech and or displayed in text on the screen 112. In some examples, the assistant LLM 160 adds a suffix to the response 166 that asks the user 10 a follow-up question related to the task 166. For instance, in the example shown, the follow-up question added to the response 166 includes “Do you want to set another alarm?” Optionally, the LLM 160 may provide an initial response 166 that prompts the user 10 to confirm that the user 10 wants the assistant LLM 160 to fulfill the task before the LLM 160 fulfills the task. Notably, the user interface 170 may display the conversational history of queries 116 and responses 166 during the spoken conversation between the user 10 and the assistant LLM 160. Notably, the textual prompts 116 displayed in the conversational history may include textual prompts 116 post-correction by the assistant LLM 160 responsive to the assistant LLM 160 applying awareness prompts to any textual prompts 116 that were initially misrecognized by the ASR system 160 when input to the assistant LLM 160.

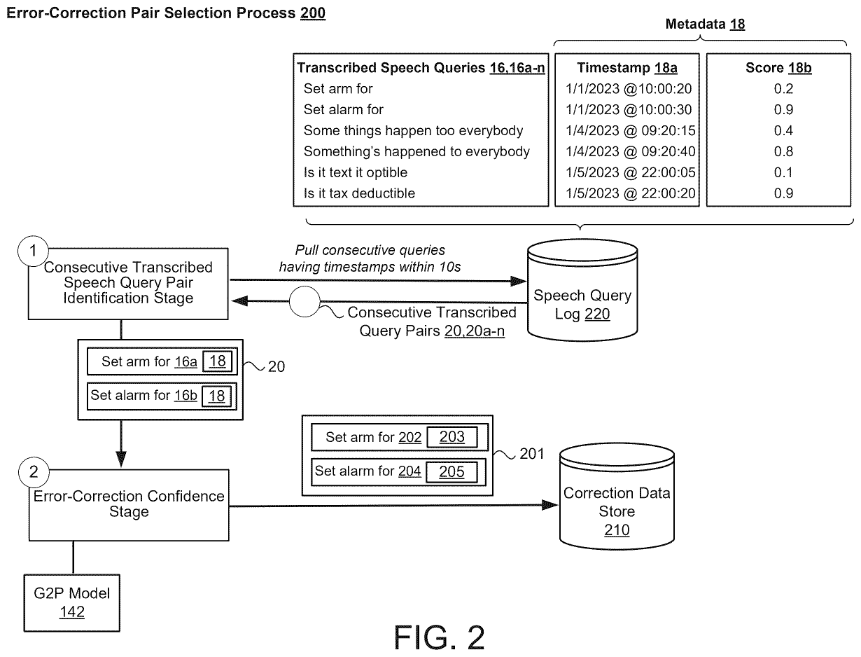

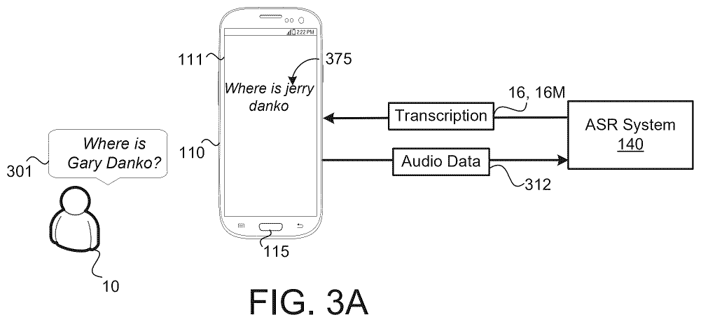

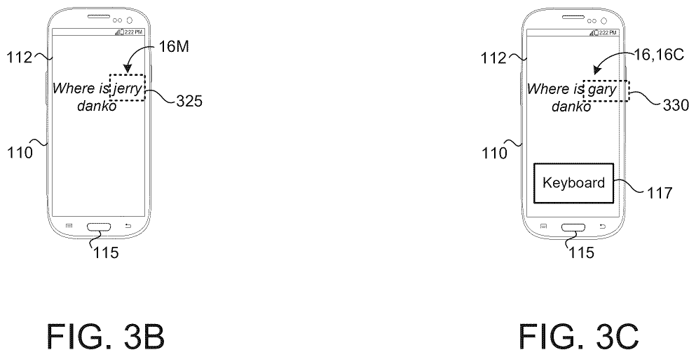

FIG. 2 is a schematic view of an example error-correction pair selection process (i.e., selection process) 200 configured to select, based on transcribed speech queries 16 obtained from one or more ASR systems, error-correction pairs 201. As will become apparent, the transcribed speech queries 16, 16a-n may correspond to transcriptions of previous queries spoken by one or more users as illustrated in FIGS. 3A-3C. The error-correction pairs 201 are stored in the correction data store 210 and may be used by the prompt structurer 150 (FIG. 1) to structure the speech misrecognition awareness prompt 155 (FIG. 1).

During a consecutive transcribed speech query pair identification stage 1, the selection process accesses a speech query log 220 that includes a corpus of transcribed speech queries 16, 16a-n and identifies consecutive transcribed speech query pairs 20, 20a-n in the corpus of transcribed speech queries 16. Notably, each corresponding transcribed speech query 16 in the corpus of transcribed speech queries 16 includes corresponding metadata 18 that indicates a corresponding timestamp 18a. For instance, the transcribed speech query 16a “Set arm for” may include corresponding metadata 18 that includes the corresponding timestamp 18 a “1/1/2023@10:00:20”. Moreover, each consecutive transcribed speech query pair 20 identified by the identification stage 1 includes a respective pair of transcribed speech queries 16a, 16b having corresponding timestamps 18a that occur within a threshold time. In the example shown, the respective pair of transcribed speech queries 16a, 16b identified by the selection process 200 to form a consecutive transcribed speech query pair 20 includes the first transcribed speech query 16 a “Set arm for” having the corresponding timestamp 18 a “1/1/2023@10:00:20” that occurs within the threshold period of time of the corresponding timestamp 18a “1/1/2023@10:00:30 for the second transcribed query 16 b “Set alarm for”. That is, when the threshold period of time is equal to some value greater than 10 seconds, the corresponding timestamps 18a of the transcribed speech queries 16a, 16b occur within the threshold period of time since the corresponding timestamps 18 a are 10 seconds apart from one another. The threshold period of time can be set equal to any value deemed sufficient for correlating two transcribed speech queries 16 as being consecutive to one another. The metadata 18 may further indicate a user or device identifier associated with the transcribed speech queries 16 stored in the speech query log 220 such that the consecutive transcribed speech query pair identification stage 1 only identifies transcribed speech queries 16 for inclusion in a corresponding consecutive transcribed speech query pair 20 that originate from a common user and/or user device. In some examples, the corresponding metadata 18 of one or more of the transcribed speech queries 16 stored in the speech query log 220 includes a phoneme representation 203, 205 of the corresponding transcribed speech query 16. The corresponding metadata 18 may be included in the identified consecutive transcribed query pair 20 alongside the respective transcribed speech query 16.

During an error-correction confidence stage 2, for each consecutive transcribed speech query pair 20 identified in the corpus of transcribed speech queries during the identification stage 1, the selection process 200 obtains a corresponding phoneme representation 203, 205 for each transcribed speech query 16 in the respective pair of transcribed speech queries 16 and determines whether the respective pair of transcribed speech queries 16 are phonetically similar to one another based on the corresponding phoneme representations 203, 205. In the example shown, for the consecutive speech query pair 20 including the first transcribed speech query 16a “Set arm for” and the second transcribed speech query 16b “Set alarm for”, the selection process 200 first obtains the corresponding phoneme representation 203, 205 for the respective pair of transcribed speech queries 16a, 16b. Here, the confidence stage 2 may pass the grapheme representation of each of the transcribed speech queries 16a, 16b to the G2P model 142 for conversion into the corresponding phoneme representation 203, 205. Alternatively, the metadata 18 for each of the transcribed speech queries 16a, 16b stored in the speech query log 220 may include the corresponding phoneme representation 203, 205. Thereafter, when the selection process 200 determines the respective pair of transcribed speech queries 16a, 16b are phonetically similar, the selection process stores the respective pair of transcribed speech queries 16a, 16b in the correction datastore 210 as a corresponding one of the candidate error-correction pairs 201 that the prompt structure 150 (FIG. 1) may include in a speech misrecognition awareness prompt 155 (FIG. 1). In the example shown, the selection process 200 further designates the transcribed speech query 16a “Set arm for” having the earlier corresponding timestamp 18a as the corresponding candidate misrecognized phrase 202 in the candidate error-correction pair 201 and designates the transcribed query 16b “Set alarm for” having the later corresponding timestamp 18a as the corresponding candidate correction phrase 204 in the candidate error-correction pair 201.

The selection process 200 may determine whether the respective pair of transcribed speech queries 16 are phonetic similarity to one another by determining whether a similarity metric between the phoneme representation 203 and the phoneme representation 205 satisfies a similarly threshold. In addition to or in lieu of using the phoneme representations 203, 205, the selection process 200 may simply determine a similarity metric between the grapheme representations of the transcribed speech queries 16a,16b. The similarity metric may be an edit distance such as a Levenshtein distance.

In some examples, the corresponding metadata 18 of each corresponding transcribed speech query 16 stored in the speech query log 220 also includes a corresponding user satisfaction score 18b associated with the corresponding transcribed speech query. Here, and in addition to determining that a respective pair of transcribed speech queries 16 are phonetically similar to one another, the selection process 200 may also consider the corresponding user satisfaction scores 18b of the respective pair of transcribed speech queries 16 included in each consecutive transcribed speech query pair 20 when determining whether the respective pair of transcribed speech queries 16 should be stored in the correction data store 210 as one of the candidate error-correction pairs 201. For example, when the corresponding user satisfaction score 18b associated with the one of the transcribed speech queries 16a having the earlier corresponding timestamp 18a satisfies a low satisfaction score threshold and the corresponding user satisfaction score 18b associated with the other one of the transcribed speech queries 16b having the later corresponding timestamp 18b satisfies a high satisfaction score threshold, the selection process 200 may store the respective pair of transcribed speech queries 16a, 16b in the correction datastore 210 as a corresponding one of the candidate error-correction pairs 201. Notably, the earlier transcribed speech query 16a having the corresponding user satisfaction score 18b satisfying the low satisfaction score threshold increases confidence that the transcribed speech query 16a is a misrecognized phrase 202 and the later transcribed speech query 16a having the corresponding user satisfaction score 18b satisfying the high satisfaction score threshold increases confidence that the transcribed speech query 16b is a correction phrase 204 that corrects the misrecognized phrase 202. The user satisfaction score 18b may be a confidence score associated with the transcribed speech query 16. This confidence score may be provided by the ASR system 140 (FIG. 1) or another ASR system that transcribed the corresponding transcribed speech query 16 to be included in the metadata 18. The confidence scores may be determined by the ASR system 140 (or other ASR system) be based on, for example, a confidence that the resulting transcribed speech query 16 matches the underlying audio data characterizing the spoken query. For instance, the ASR system may provide one or more-word lattices that represent multiple possible combinations of words that may form different candidate hypotheses for the candidate transcription. The confidence score can be based on how well the word fits grammatically and/or lexically with other words in the word lattice. In some examples, the user satisfaction score 18b may be assigned by a user. In some examples, the user satisfaction score 18b may be determined based on the user previously identifying the corresponding transcribed speech query as a misrecognized transcription 16M (FIG. 3A). Similarly, the user satisfaction score 18b may be determined based on the user previously identifying the corresponding transcribed speech query as a corrected transcription 16C (FIG. 3C).

In some examples, the correction datastore 210 includes a personal correction datastore associated with the user 10 that issued the natural language query 116 (FIG. 1). In these examples, the corpus of transcribed speech queries 16 in the speech query log 220 accessed by the selection process 200 are all issued by the same user 10 that issued the natural language query 116 in FIG. 1. As such, the error-correction pairs 201 stored in the correction datastore 210 are all associated with the same user 10 issuing the natural language query 116 in FIG. 1 so that only error-correction pairs 201 derived from that user 10 are included the speech misrecognition awareness prompts 155 structured by the prompt structurer 150 for that user 10. In some examples, error-correction pairs 201 having corresponding timestamps 18a occurring within a threshold time before the current textual query (i.e., utterance) 116 provided to the prompt structure 150 are considered for inclusion in the speech misrecognition awareness prompt 155. In this manner, the error-correction pairs 201 include transcribed speech queries that are more recent and have a higher likelihood of being relevant to a current textual query 116 derived from the user 10.

In some examples, the correction datastore 210 includes a global correction datastore and the candidate error-correction pairs 201 stored in the global correction datastore are obtained from multiple different users. In these examples, the corpus of transcribed speech queries 16,16 in the speech query log 220 accessed by the selection process 200 may be issued by the multiple different users. The prompt structurer 150 (FIG. 1) may weight error-correction pairs 201 extracted from the user's personal correction datastore differently than the error-correction pairs 201 extracted from the global correction datastore.

FIGS. 3A-3C illustrate correcting a misrecognized transcription and storing the misrecognized transcription and corresponding corrected transcription in the speech query log 220 of FIG. 2. In some implementations, the ASR system 140 generates a misrecognized transcription 16, 16M that misrecognizes a previous query 301 spoken by the user 10. As used herein, the previous query 301 and the misrecognized transcription 16M are received at the user device 110 at a prior time to receiving the query 116 (FIG. 1). In these implementations, a corrected transcription 16, 16C that represents an accurate transcription of the previous query 301 may be generated. As will become apparent, the misrecognized transcription 16M and corrected transcription 16C can be stored in the speech query log 220 (FIG. 2) and used by the error-correction pair selection process 200 for selecting error-correction pairs 201 (FIG. 1) to be stored in the correction datastore 210 (FIG. 1) for correcting potentially misrecognized textual prompts 116 directed toward the LLM-powered assistant 160.

FIG. 3A illustrates the microphone 115 of the user device 110 recording the user 10 speaking a previous query 301 “Where is Gary Danko.” The user device 110 converts the previous query 301 to audio data 312 and provides the audio data 312 to the ASR system 140. The ASR system 140 processes the audio data 312 to generate the misrecognized transcription 16M corresponding to the audio data 312. In the example shown, the ASR system 140 generates the misrecognized transcription 16M “Where is Jerry Danko” which is a misrecognition of the previous query 301 spoken by the user 10. The user device 110 displays the previous transcription 16M to the user 10 via the screen 112 of the user device.

Referring now to FIG. 3B, the user 10 may identify that the misrecognized transcription 16M displayed on the screen 112 does not match the previous query 301. As such, the user 10 provides an input indication to the screen 112 of the user device 110 that indicates a selection of a misrecognized phrase 325 in the misrecognized transcription 16M. In some examples, the input indication includes the user 10 providing a touch input to the screen 112 that selects the misrecognized phrase 325 from the misrecognized transcription 16M. The misrecognized phrase 325 may include the entire misrecognized transcription 16M or a portion thereof. In the example shown, the misrecognized phrase 325 “jerry” only includes an incorrect portion of the previous transcription 16M.

FIG. 3C illustrates the user 10 replacing the misrecognized phrase 325 in the misrecognized transcription 16M with a corrected phrase 330. In some examples, the user 10 inputs text to provide the corrected phrase 330 using a keyboard 117 of the user device 110. Optionally, user device 110 may display the keyboard 117 in response to the user device 110 receiving the input indication from the user 10 (FIG. 3B). In these examples, the user 10 may type in the corrected phrase (e.g., “gary”) using the keyboard 117 of the user device 110. In other examples, the user 10 inputs the corrected phrase 330 by speaking to the user device 110. For instance, the user 10 may speak each letter of the corrected phrase 330 (e.g., “G-A-R-Y”). After receiving the corrected phrase 330, the user device 110 replaces the misrecognized phrase 325 with the corrected phrase 330 to generate the corrected transcription 16C that represents an accurate transcription of the previous query 301.

Accordingly, the user device 110 and/or the remote system 120 may store (i.e., at the memory hardware 114 of the user device 110 and/or the memory hardware 124 of the remote system 120) the misrecognized transcription 16M, the misrecognized phrase 325, the corrected transcription 16C, and/or the corrected phrase 330 in the speech query log 220 (FIG. 2). In some implementations, the misrecognized transcription 16M and the corrected transcription 16C are included in an error-correction pair 201 and be stored in the correction data sore 210 directly.

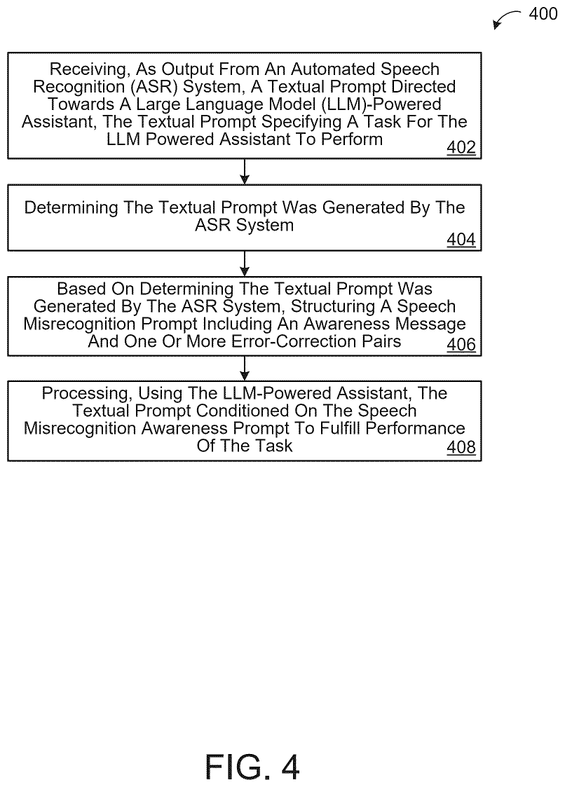

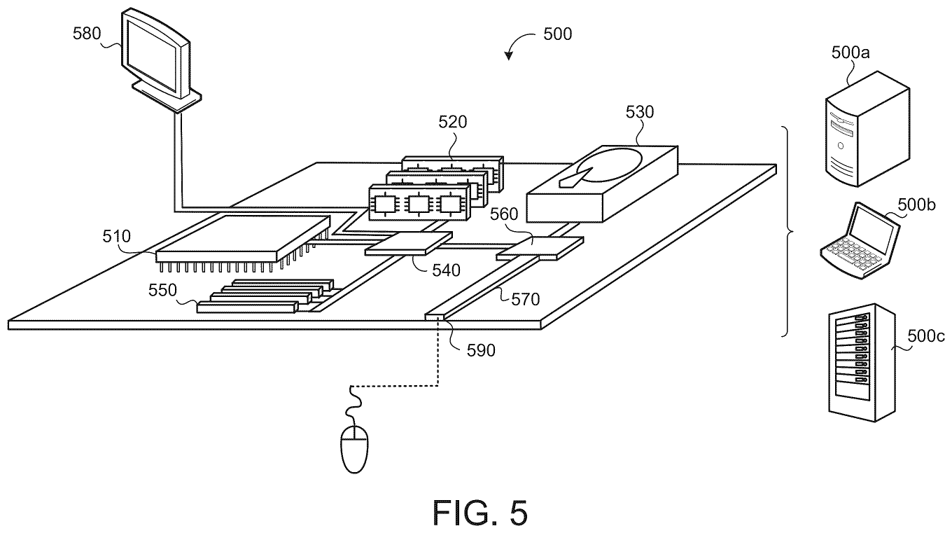

FIG. 4 is a flowchart of an exemplary arrangement of operations for a computer-implemented method 400 of correcting textual prompts 116 directed toward a LLM-powered assistant 160 that were generated by an ASR system 140. The operations may be performed by data processing hardware 510 (FIG. 5) (e.g., the data processing hardware 113 of the user device 110 or the data processing hardware 123 of the remote system 120) based on executing instructions stored on memory hardware 520 (e.g., the memory hardware 114 of the user device 110 or the memory hardware 124 of the remote computing system 120) in communication with the data processing hardware 510.

At operation 402, the method 400 includes receiving, as output from an automated speech recognition (ASR) system 140, a textual prompt 116 directed toward a large language model (LLM)-powered assistant 160. The ASR system 140 is configured to generate the textual prompt 116 from input audio data 102 characterizing an utterance of a natural language query 116 that specifies a task 166 for the LLM-powered assistant 160 to perform. At operation 404, the method 400 includes determining the textual prompt 116 was generated by the ASR system 140.

At operation 406, the method 400 includes structuring a speech misrecognition awareness prompt 155 based on determining the textual prompt 116 was generated by the ASR system 140. The speech misrecognition awareness prompt 155 includes an awareness message 120 that informs the LLM-powered assistant 160 that the text prompt 116 was generated by the ASR system 140 and may be prone to speech recognition errors and one or more error-correction pairs 201. Here, each error-correction pair includes a corresponding misrecognized phrase 202 and a corresponding correction phrase 204 that corrects the corresponding misrecognized phrase 202. At operation 408, the method 400 includes processing, using the LLM-powered assistant 160, the textual prompt 116 conditioned on the speech misrecognition awareness prompt 155 to fulfill performance of the task 166 specified by the natural language query 116.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

FIG. 5 is schematic view of an example computing device 500 that may be used to implement the systems and methods described in this document. The computing device 500 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 500 includes a processor 510, memory 520, a storage device 530, a high-speed interface/controller 540 connecting to the memory 520 and high-speed expansion ports 550, and a low speed interface/controller 560 connecting to a low speed bus 570 and a storage device 530. Each of the components 510, 520, 530, 540, 550, and 560, are interconnected using various busses, and may be mounted on a common motherboard or in other manners as appropriate. The processor 510 can process instructions for execution within the computing device 500, including instructions stored in the memory 520 or on the storage device 530 to display graphical information for a graphical user interface (GUI) on an external input/output device, such as display 580 coupled to high speed interface 540. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 520 stores information non-transitorily within the computing device 500. The memory 520 may be a computer-readable medium, a volatile memory unit(s), or non-volatile memory unit(s). The non-transitory memory 520 may be physical devices used to store programs (e.g., sequences of instructions) or data (e.g., program state information) on a temporary or permanent basis for use by the computing device 500. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 530 is capable of providing mass storage for the computing device 500. In some implementations, the storage device 530 is a computer-readable medium. In various different implementations, the storage device 530 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer-or machine-readable medium, such as the memory 520, the storage device 530, or memory on processor 510.

The high speed controller 540 manages bandwidth-intensive operations for the computing device 500, while the low speed controller 560 manages lower bandwidth-intensive operations. Such allocation of duties is exemplary only. In some implementations, the high-speed controller 540 is coupled to the memory 520, the display 580 (e.g., through a graphics processor or accelerator), and to the high-speed expansion ports 550, which may accept various expansion cards (not shown). In some implementations, the low-speed controller 560 is coupled to the storage device 530 and a low-speed expansion port 590. The low-speed expansion port 590, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 500a or multiple times in a group of such servers 500a, as a laptop computer 500b, or as part of a rack server system 500c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks, The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method executing on data processing hardware that causes the data processing hardware to perform operations comprising:
receiving, as output from an automated speech recognition (ASR) system, a textual prompt directed toward a large language model (LLM)-powered assistant, the ASR system configured to generate the textual prompt from input audio data characterizing an utterance of a natural language query that specifies a task for the LLM-powered assistant to perform;
determining the textual prompt was generated by the ASR system;
based on determining the textual prompt was generated by the ASR system, structuring a speech misrecognition awareness prompt, the speech misrecognition awareness prompt comprising:
an awareness message that informs the LLM-powered assistant that the text prompt was generated by the ASR system and may be prone to speech recognition errors; and
one or more error-correction pairs, each error-correction pair comprising a corresponding misrecognized phrase and a corresponding correction phrase that corrects the corresponding misrecognized phrase; and
processing, using the LLM-powered assistant, the textual prompt conditioned on the speech misrecognition awareness prompt to fulfill performance of the task specified by the natural language query.

2. The method of claim 1, wherein the operations further comprise;
generating, as output from the LLM-powered assistant, a response indicating performance of the task specified by the natural language query; and
providing, for output from a user device, the response generated as output from the LLM-powered assistant.

3. The method of claim 1, wherein the one or more error-correction pairs are fixed.

4. The method of claim 1, wherein the operations further comprise, based on determining the textual prompt was generated by the ASR system:
processing the textual prompt to generate a corresponding phoneme representation of the textual prompt; and
querying, using the corresponding phoneme representation of the textual prompt, a corrections datastore to retrieve any candidate error-correction pairs stored in the corrections datastore that are phonetically similar to the textual prompt,
wherein the one or more error-correction pairs of the speech misrecognition awareness prompt comprise each candidate error-correction pair retrieved from the correction datastore that is phonetically similar to the textual prompt.

5. The method of claim 4, wherein:
each candidate error-correction pair stored in the correction data store comprises:
a candidate misrecognized phrase;
a corresponding phoneme representation of the candidate misrecognized phrase;
a candidate correction phrase that corrects the candidate misrecognized phrase; and
a corresponding phoneme representation of the candidate correction phrase; and
retrieving any candidate error-correction pairs stored in the corrections datastore that are phonetically similar to the textual prompt comprises, for each corresponding candidate error-correction pair stored in the correction datastore:
determining whether a corresponding similarity metric between the corresponding phoneme representation of the textual prompt and the corresponding phoneme representation of at least one of the candidate misrecognized phrase or the candidate correction phrase satisfies a similarity threshold; and
when the corresponding similarity metric satisfies the similarity threshold, retrieving the corresponding candidate error-correction pair.

6. The method of claim 5, wherein:
the corresponding phoneme representation of each of the textual prompt, the candidate misrecognized phrase, and the candidate correction phrase comprises a corresponding phoneme sequence; and
the corresponding similarity metric comprises an edit distance.

7. The method of claim 1, wherein:
the one or more error-correction pairs of the speech misrecognition awareness prompt are stored in a correction datastore that stores candidate error-correction pairs; and
a selection process selects each corresponding candidate error-correction pair stored in the correction datastore by:
accessing a speech query log comprising a corpus of transcribed speech queries, each corresponding transcribed speech query in the corpus of transcribed speech queries comprising corresponding metadata that indicates a corresponding timestamp of the corresponding transcribed speech query;
identifying consecutive transcribed speech query pairs in the corpus of transcribed speech queries, each consecutive transcribed speech query pair including a respective pair of transcribed speech queries having corresponding timestamps that occur within a threshold time; and
for each consecutive transcribed speech query pair identified in the corpus of transcribed speech queries:
obtaining a corresponding phoneme representation for each transcribed speech query in the respective pair of transcribed speech queries,
determining whether the respective pair of transcribed speech queries are phonetically similar to one another based on the corresponding phoneme representations of the respective pair of transcribed speech queries; and
based on when the respective pair of transcribed speech queries are phonetically similar, storing the respective pair of transcribed speech queries in the correction datastore as a corresponding one of the candidate error-correction pairs, wherein the one of the transcribed speech queries in the respective pair of transcribed speech queries that has the earlier corresponding timestamp comprises the corresponding candidate misrecognized phrase and the other one of the transcribed speech queries in the respective pair of transcribed speech queries that has the later corresponding time stamp comprises the corresponding candidate correction phrase.

8. The method of claim 7, wherein:
the corresponding metadata of each corresponding transcribed speech query in the corpus of transcribed speech queries further indicates a corresponding user satisfaction score associated with the corresponding transcribed speech query; and
for each consecutive transcribed speech query pair, storing the respective pair of transcribed speech queries in the correction datastore as a corresponding one of the candidate error-correction pairs is further based on when:
the corresponding user satisfaction score associated with the one of the transcribed speech queries in the respective pair of transcribed speech queries that has the earlier corresponding timestamp satisfies a low satisfaction score threshold; and
the corresponding user satisfaction score associated with the other of the transcribed speech queries in the respective pair of transcribed speech queries that has the later corresponding timestamp satisfies a high satisfaction score threshold.

9. The method of claim 7, wherein:
the correction datastore comprises a personal correction datastore associated with a user that issued the natural language query; and
the corpus of transcribed speech queries in the speech query log accessed by the selection process are all issued by the same user that issued the natural language query.

10. The method of claim 7, wherein:
the correction datastore comprises a global correction datastore and the candidate error-correction pairs stored in the global correction datastore are obtained from multiple different users; and
the corpus of transcribed speech queries in the speech query log accessed by the selection process are issued by the multiple different users.

11. A system comprising:
data processing hardware; and
memory hardware in communication with the data processing hardware, the memory hardware storing instructions that when executed on the data processing hardware cause the data processing hardware to perform operations comprising:
receiving, as output from an automated speech recognition (ASR) system, a textual prompt directed toward a large language model (LLM)-powered assistant, the ASR system configured to generate the textual prompt from input audio data characterizing an utterance of a natural language query that specifies a task for the LLM-powered assistant to perform;
determining the textual prompt was generated by the ASR system;
based on determining the textual prompt was generated by the ASR system, structuring a speech misrecognition awareness prompt, the speech misrecognition awareness prompt comprising:
an awareness message that informs the LLM-powered assistant that the text prompt was generated by the ASR system and may be prone to speech recognition errors; and
one or more error-correction pairs, each error-correction pair comprising a corresponding misrecognized phrase and a corresponding correction phrase that corrects the corresponding misrecognized phrase; and
processing, using the LLM-powered assistant, the textual prompt conditioned on the speech misrecognition awareness prompt to fulfill performance of the task specified by the natural language query.

12. The system of claim 11, wherein the operations further comprise:
generating, as output from the LLM-powered assistant, a response indicating performance of the task specified by the natural language query; and
providing, for output from a user device, the response generated as output from the LLM-powered assistant.

13. The system of claim 11, wherein the one or more error-correction pairs are fixed.

14. The system of claim 11, wherein the operations further comprise, based on determining the textual prompt was generated by the ASR system:
processing the textual prompt to generate a corresponding phoneme representation of the textual prompt; and
querying, using the corresponding phoneme representation of the textual prompt, a corrections datastore to retrieve any candidate error-correction pairs stored in the corrections datastore that are phonetically similar to the textual prompt,
wherein the one or more error-correction pairs of the speech misrecognition awareness prompt comprise each candidate error-correction pair retrieved from the correction datastore that is phonetically similar to the textual prompt.

15. The system of claim 14, wherein:
each candidate error-correction pair stored in the correction data store comprises:
a candidate misrecognized phrase;
a corresponding phoneme representation of the candidate misrecognized phrase;
a candidate correction phrase that corrects the candidate misrecognized phrase; and
a corresponding phoneme representation of the candidate correction phrase; and
retrieving any candidate error-correction pairs stored in the corrections datastore that are phonetically similar to the textual prompt comprises, for each corresponding candidate error-correction pair stored in the correction datastore:
determining whether a corresponding similarity metric between the corresponding phoneme representation of the textual prompt and the corresponding phoneme representation of at least one of the candidate misrecognized phrase or the candidate correction phrase satisfies a similarity threshold; and
when the corresponding similarity metric satisfies the similarity threshold, retrieving the corresponding candidate error-correction pair.

16. The system of claim 15, wherein:
the corresponding phoneme representation of each of the textual prompt, the candidate misrecognized phrase, and the candidate correction phrase comprises a corresponding phoneme sequence; and
the corresponding similarity metric comprises an edit distance.

17. The system of claim 14, wherein:
the one or more error-correction pairs of the speech misrecognition awareness prompt are stored in a correction datastore that stores candidate error-correction pairs, and
a selection process selects each corresponding candidate error-correction pair stored in the correction datastore by:
accessing a speech query log comprising a corpus of transcribed speech queries, each corresponding transcribed speech query in the corpus of transcribed speech queries comprising corresponding metadata that indicates a corresponding timestamp of the corresponding transcribed speech query;
identifying consecutive transcribed speech query pairs in the corpus of transcribed speech queries, each consecutive transcribed speech query pair including a respective pair of transcribed speech queries having corresponding timestamps that occur within a threshold time; and
for each consecutive transcribed speech query pair identified in the corpus of transcribed speech queries:
obtaining a corresponding phoneme representation for each transcribed speech query in the respective pair of transcribed speech queries;
determining whether the respective pair of transcribed speech queries are phonetically similar to one another based on the corresponding phoneme representations of the respective pair of transcribed speech queries; and
based on when the respective pair of transcribed speech queries are phonetically similar, storing the respective pair of transcribed speech queries in the correction datastore as a corresponding one of the candidate error-correction pairs, wherein the one of the transcribed speech queries in the respective pair of transcribed speech queries that has the earlier corresponding timestamp comprises the corresponding candidate misrecognized phrase and the other one of the transcribed speech queries in the respective pair of transcribed speech queries that has the later corresponding time stamp comprises the corresponding candidate correction phrase.

18. The system of claim 17, wherein:
the corresponding metadata of each corresponding transcribed speech query in the corpus of transcribed speech queries further indicates a corresponding user satisfaction score associated with the corresponding transcribed speech query; and
for each consecutive transcribed speech query pair, storing the respective pair of transcribed speech queries in the correction datastore as a corresponding one of the candidate error-correction pairs is further based on when:
the corresponding user satisfaction score associated with the one of the transcribed speech queries in the respective pair of transcribed speech queries that has the earlier corresponding timestamp satisfies a low satisfaction score threshold; and
the corresponding user satisfaction score associated with the other of the transcribed speech queries in the respective pair of transcribed speech queries that has the later corresponding timestamp satisfies a high satisfaction score threshold.

19. The system of claim 17, wherein:
the correction datastore comprises a personal correction datastore associated with a user that issued the natural language query; and
the corpus of transcribed speech queries in the speech query log accessed by the selection process are all issued by the same user that issued the natural language query.

20. The system of claim 17, wherein:
the correction datastore comprises a global correction datastore and the candidate error-correction pairs stored in the global correction datastore are obtained from multiple different users; and
the corpus of transcribed speech queries in the speech query log accessed by the selection process are issued by the multiple different users.
